(19) United States
(12) Patent Application Publication
(10) Pub. No.: US 2014/0152195 A1
(43) Pub. Date: Jun. 5, 2014

(54) Method for Overcoming Excessively High Temperature of Constant Current Driving Chip and LED Light Bar Driving Circuit

(71) Applicant: Shenzhen China Star Optoelectronics Technology Co. Ltd., Shenzhen City, Guangdong Province (CN)

(72) Inventors: Hua Zhang, Shenzhen City (CN); Fei Li, Shenzhen City (CN)

(73) Assignee: Shenzhen China Star Optoelectronics Technology Co., LTD, Shenzhen City, Guangdong Province (CN)

(21) Appl. No.: 13/807,718

(22) PCT Filed: Nov. 25, 2012
(86) PCT No.: PCT/CN2012/085229

§ 371 Date: Dec. 28, 2012

(30) Foreign Application Priority Data
Nov. 14, 2012 (CN) 201210457421.8

(51) Int. Cl. H05B 33/08

(52) U.S. Cl. CPC H05B 33/0842
USPC 315/320

(57) ABSTRACT

The invention provides a method for overcoming excessively high temperature of a constant current driving chip and an LED light bar driving circuit. The method includes (1) providing dual-channel constant current driving chips, each including first and second input pins, first and second output pins, and a control pin; (2) providing LED light bars, resistors, a control source, and a power source; (3) connecting ends of one light bar to the power source and the first input pin, connecting ends of another light bar to the power source and the second input pin, connecting ends of one resistor to the first output pin and grounding, connecting ends of another resistor to the second output pin and grounding, and connecting the control source to the control pin; (4) repeating step (3) until the light bars are connected; and (5) activating the control source and the power source to drive the light bars.

### BACKGROUND OF THE INVENTION

1. Field of the Invention

The present invention relates to the field of driving of LED (Light-Emitting Diode) light, and in particular to a method for overcoming excessively high temperature of a constant current driving chip and an LED light bar driving circuit.

2. The Related Arts

LED is a solid state light source, which uses re-combination of electrons and electron holes in a semiconductor to emit photons. The color emitting from an LED is determined by the energy of photons and the energy of photons is determined by the material used. The same material gives substantially identical wavelength of the emitted light and thus, each LED gives off a pure color. The most commonly known LEDs of regular brightness include red color and green color. The LEDs have small sizes of die, have diversified colors, and provide significant flexibility in arrangement for use, these being the factors making them superior to the ordinary light source. Further, compared to the other light sources, the LEDs also provide relatively high light efficiency and relatively high reliability and the way of power supplying thereto is relatively simple. Thus, the LEDs are particularly fit to serving as a light source for displaying.

Similar to a PN junction of a regular semiconductor, voltage drop of forward conduction of an LED hardly varies with conduction current and is generally approximately 3.5V, but the illumination increases with the increase of the current flowing therethrough, so that the larger the current is, the larger the optic output and illumination will be. Thus, LEDs must use serially-connected power supply and a constant current power supply, so that the electrical current flowing through the diode is constant in order to maintain stable optical output. For a driving chip for LEDs, the output must feature constant current to power serially connected LEDs.

Referring to FIG. 1, to lower down the cost, the manufacturers of the constant current driving chips that are currently available in the market integrate an MOS transistor (or a triode) that controls current in a constant current driving chip to form a highly-integrated, multi-channel, MOS transistor contained an LED constant current driving chip. Such a highly-integrated constant current driving chip may simplify the circuit structure, yet integrating the MOS transistor in the constant current driving chip would make excessive current of an LED light bar directly applied to pins of the constant current driving chip to thereby generate, together with the current flowing through the MOS transistor, heat loss, leading to temperature rise of the constant current driving chip. For a currently available constant current driving chip that comprises 8 channels or 16 channels integrated together, the temperature of an LED backlight driving circuit may get excessively high in operation and may easily get beyond the standard operation specification. This affects product performance and greatly deteriorates stability and reliability of products.

### SUMMARY OF THE INVENTION

An object of the present invention is to provide a method for overcoming excessively high temperature of a constant current driving chip, which spreads the heat loss occurring in the prior art to a plurality of constant current driving chips so as to reduce the operation temperature of the constant current driving chips and improve stability and reliability of products.

Another object of the present invention is to provide an LED light bar driving circuit, which comprises a dual-channel constant current driving chip to effectively reduce the temperature of an individual constant current driving chip so as to lower the operation temperature of the constant current driving chip and improve stability and reliability of products.

To achieve the objects, the present invention provides a method for overcoming excessively high temperature of a constant current driving chip, which comprises the following steps:

(1) providing a plurality of constant current driving chips, wherein the constant current driving chips are dual-channel constant current driving chips and each of the constant current driving chips comprises a first input pin, a second input pin, a first output pin, a second output pin, and a control pin;

(2) providing a control source, a power source, and a plurality of LED light bars and a plurality of resistors both having a number corresponding to that of the constant current driving chips, each of the LED light bars having a positive terminal and a negative terminal;

(3) respectively connecting the positive terminal and the negative terminal of one of the LED light bars to the power source and the first input pin of one of the constant current driving chips and respectively connecting the positive terminal and the negative terminal of another one of the LED light bars to the power source and the second input pin of the constant current driving chip, also connecting an end of one of the resistors to the first output pin of the constant current driving chip and an opposite end to a grounding line, and also connecting an end of another one of the resistors to the second output pin of the constant current driving chip and an opposite end to the grounding line, connecting the control source to the control pin;

(4) repeating Step 3, until a predetermined number of the LED light bars are connected; and

(5) activating the control source and the power source so as to apply the control source to control the corresponding LED light bars to conduct on or cut off.

Using a plurality of dual-channel constant current driving chips to replace the conventional highly-integrated constant current driving chip can distribute heat loss and thus lower down the operation temperature of the constant current driving chips and improve stability and reliability of products.

Each of the constant current driving chips integrates therein two field-effect transistors or two triodes, whereby the field-effect transistors or triodes control the corresponding LED light bars to conduct on or cut off in a safe and reliable manner.

The control source supplies a high level or a low level to control the field-effect transistors or the triodes contained in the constant current driving chips to conduct on or cut off, the high level being greater than voltage of the drain terminal when the field-effect transistor is conducted on and being also greater than a threshold voltage of the field-effect transistor so as to ensure normal conduction or cutoff the field-effect transistor.

The resistances of the resistors are determined according to predetermined brightness of the LED light bars so that the lighting brightness of the LED light bars can be controlled through controlling the electrical current flowing through the LED light bars.

The present invention also provides an LED light bar driving circuit, which comprises a power source, two LED light bars, a dual-channel constant current driving chip, two resistors, and a control source. Each of the LED light bars comprises a positive terminal and a negative terminal. The constant current driving chip comprises a first input pin, a second input pin, a first output pin, a second output pin, and a control pin. The positive terminal and the negative terminal of one of the LED light bars are respectively connected to the power source and the first input pin of the constant current driving chip. The positive terminal and the negative terminal of another one of the LED light bars are respectively connected to the power source and the second input pin of the constant current driving chip. One of the resistors has an end connected to the first output pin of the constant current driving chip and an opposite end connected to a grounding line. Another one of the resistors has an end connected to the second output pin of the constant current driving chip and an opposite end connected to the grounding line. The control pin is electrically connected to the control source.

Using a plurality of dual-channel constant current driving chips to replace the conventional highly-integrated constant current driving chip can distribute heat loss and thus lower down the operation temperature of the constant current driving chips and improve stability and reliability of products.

Each of the constant current driving chips integrates therein two field-effect transistors or two triodes, whereby the field-effect transistors or triodes control the corresponding LED light bars to conduct on or cut off in a safe and reliable manner.

The control source supplies a high level or a low level to control the field-effect transistors or the triodes contained in the constant current driving chips to conduct on or cut off, the high level being greater than voltage of the drain terminal when the field-effect transistor is conducted on and being also greater than a threshold voltage of the field-effect transistor so as to ensure normal conduction or cutoff the field-effect transistor.

The resistances of the resistors are determined according to predetermined brightness of the LED light bars so that the lighting brightness of the LED light bars can be controlled through controlling the electrical current flowing through the LED light bars.

The present invention further provides a method for overcoming excessively high temperature of a constant current driving chip, which comprises the following steps:

(1) providing a plurality of constant current driving chips, wherein the constant current driving chips are dual-channel constant current driving chips and each of the constant current driving chips comprises a first input pin, a second input pin, a first output pin, a second output pin, and a control pin;

(2) providing a control source, a power source, and a plurality of LED light bars and a plurality of resistors both having a number corresponding to that of the constant current driving chips, each of the LED light bars having a positive terminal and a negative terminal;

(3) respectively connecting the positive terminal and the negative terminal of one of the LED light bars to the power source and the first input pin of one of the constant current driving chips and respectively connecting the positive terminal and the negative terminal of another one of the LED light bars to the power source and the second input pin of the constant current driving chip, also connecting an end of one of the resistors to the first output pin of the constant current driving chip and an opposite end to a grounding line, and also connecting an end of another one of the resistors to the second output pin of the constant current driving chip and an opposite end to the grounding line, connecting the control source to the control pin;

(4) repeating Step 3, until a predetermined number of the LED light bars are connected; and

(5) activating the control source and the power source so as to apply the control source to control the corresponding LED light bars to conduct on or cut off;

wherein each of the constant current driving chips integrates therein two field-effect transistors or two triodes;

wherein the control source supplies a high level or a low level to control the field-effect transistors or the triodes contained in the constant current driving chips to conduct on or cut off, the high level being greater than voltage of the drain terminal when the field-effect transistor is conducted on and being also greater than a threshold voltage of the field-effect transistor; and

wherein the resistances of the resistors are determined according to predetermined brightness of the LED light bars.

The efficacy of the present invention is that the present invention provides a method for overcoming excessively high temperature of a constant current driving chip, which comprises a plurality of dual-channel constant current driving chips to replace a conventional 8-channel or 16-channel highly integrated constant current driving chip for driving LED light bars, whereby by reducing the number of channels contained in each individual constant current driving chip, the operation temperature of each individual constant current driving chip can be reduced so as to ensure the performance of products and overcome the heat generation issue caused by high integration of a constant current driving chip and improve stability and reliability of products. The present invention also provides an LED light bar driving circuit, which uses dual-channel constant current driving chips in order to effectively reduce heat emission of each individual constant current driving chip, lower down the operation temperature of the constant current driving chip, and improve stability and reliability of products.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 is a schematic view showing the connection of a conventional 8-channel constant current driving chip;

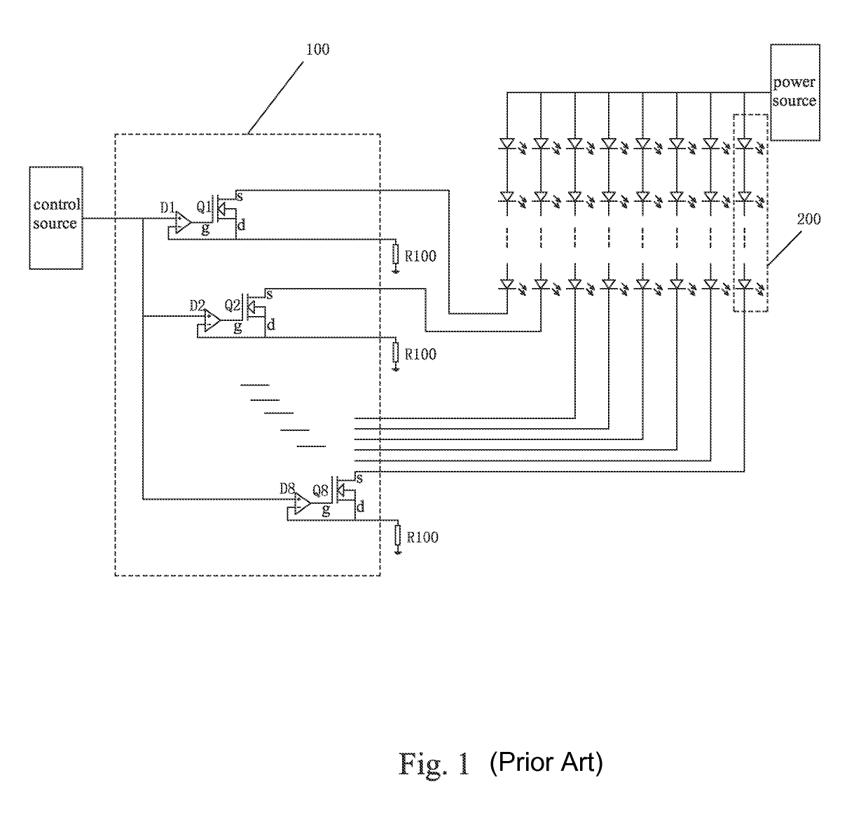

FIG. 2 is a flow chart illustrating a method for overcoming excessively high temperature of a constant current driving chip according to the present invention; and

FIG. 3 is a schematic view showing the connection of a constant current driving chip according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

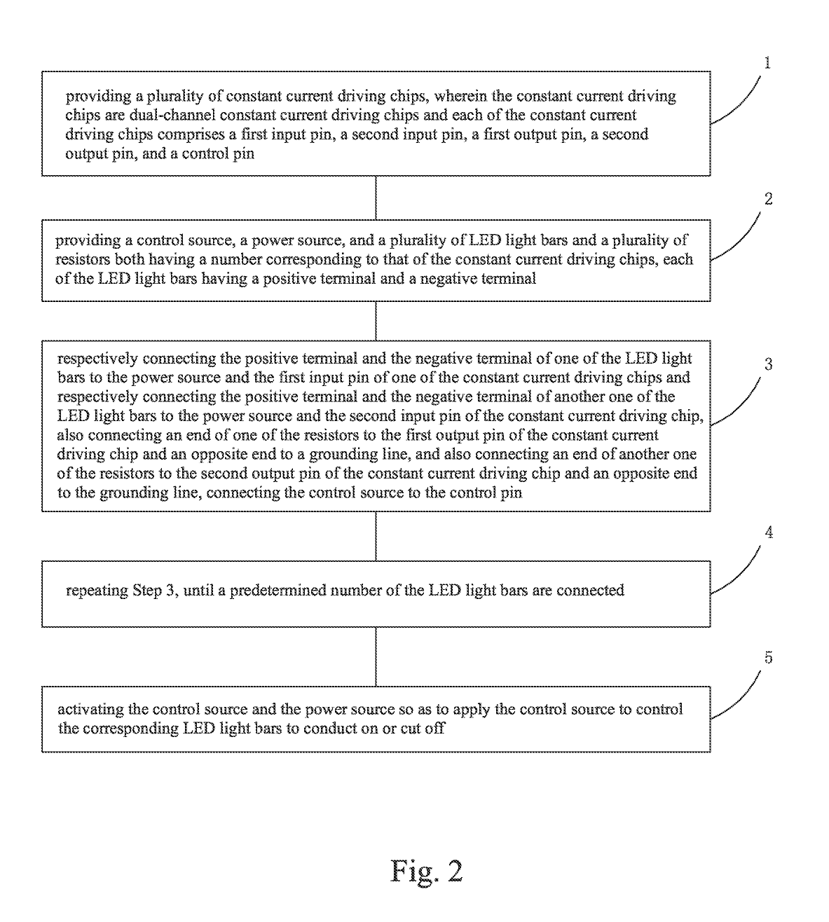

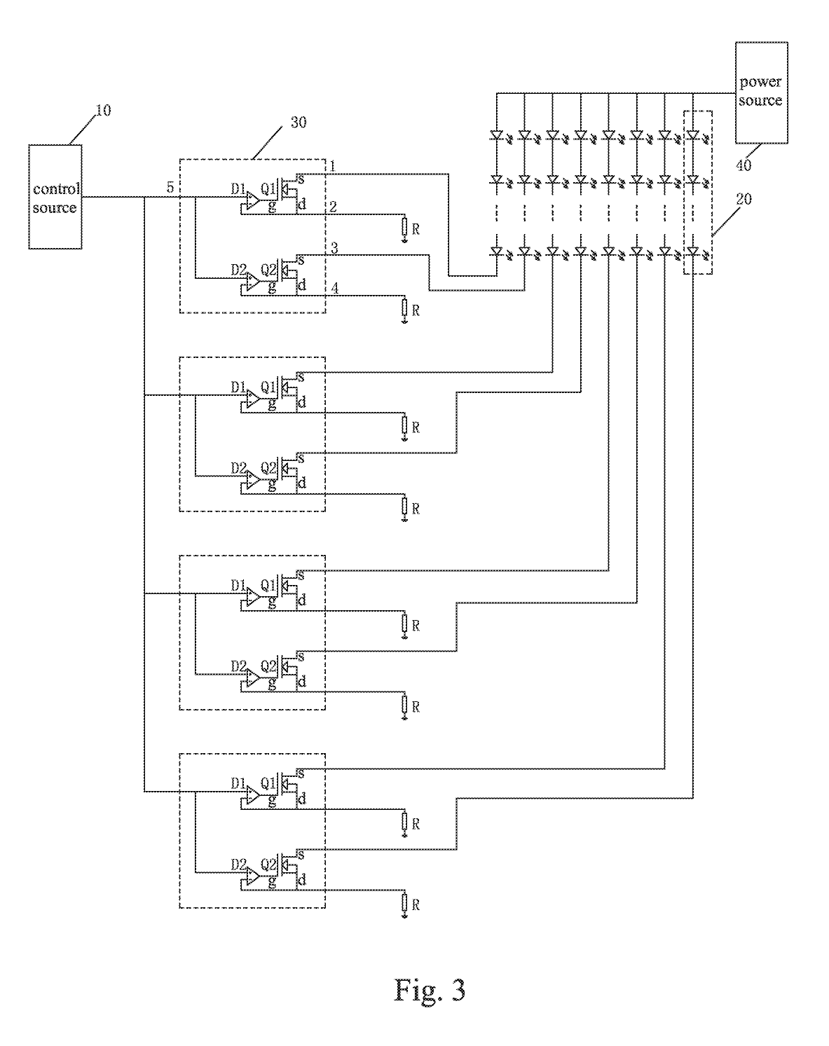

Referring to FIGS. 2 and 3, the present invention provides a method for overcoming excessively high temperature of a constant current driving chip, which comprises the following steps:

Step 1: providing a plurality of constant current driving chips 30, wherein the constant current driving chips 30 are dual-channel constant current driving chips and each of the constant current driving chips 30 comprises a first input pin 1, a second input pin 3, a first output pin 2, a second output pin 4, and a control pin 5.

Each of the constant current driving chips 30 integrates therein two field-effect transistors (Q1 and Q2) or two triodes (field-effect transistors being taken as an example in FIG. 3) to realize dual-channel control, which is safe and reliable.

Step 2: providing a control source 10, a power source 40, and a plurality of LED light bars 20 and a plurality of resistors R both having a number corresponding to that of the constant current driving chips 30, each of the LED light bars 20 having a positive terminal and a negative terminal.

The resistances of the resistors R are determined according to the desired brightness of the LED light bars 20 and the resistances of the resistors R can be identical or different. If the resistances of the resistors R are identical, then the brightness of each of the plurality of LED light bars 20 is identical. If the resistances of the resistors R are different, then the brightness of each of the plurality of LED light bars 20 is different so that applications thereof can be made to various occasions for atmosphere making.

The constant current driving chips 30 each also comprise two voltage comparators D1 and D2. Each of the voltage comparators D1, D2 has an output pin electrically connected to a gate terminal g of the one of the field-effect transistors Q1, Q2 that corresponds to the voltage comparator D1, D2, a negative pin electrically connected to a drain terminal d of the field-effect transistor Q1, Q2, and a positive pin electrically connected to the control source 10. The control source 10 supplies a high level or a low level, of which the high level is greater than the voltage of the drain terminal d when the field-effect transistor Q1, Q2 is conducted on and is also greater than a threshold voltage of the field-effect transistor Q1, Q2 so as to control the conduction or cutoff of the field-effect transistor Q1, Q2 or the triode contained in the constant current driving chip 30, wherein when the control source 10 supplies a high level, the voltage of the positive pin of the voltage comparator D1, D2 is higher than that of the negative pin and thus the output pin supplies a high level to thereby control the corresponding field-effect transistor Q1, Q2 to conduct on and when the control source 10 supplies a low level, the voltage of the positive pin of the voltage comparator D1, D2 is lower than that of the negative pin and thus the output pin supplies a low level to thereby control the corresponding field-effect transistor Q1, Q2 to cut off.

Step 3: respectively connecting the positive terminal and the negative terminal of one of the LED light bars 20 to the power source and the first input pin 1 of one of the constant current driving chips 30 and respectively connecting the positive terminal and the negative terminal of another one of the LED light bars 20 to the power source 40 and the second input pin 3 of the constant current driving chip 30, also connecting an end of one of the resistors R to the first output pin 2 of the constant current driving chip 30 and an opposite end to a grounding line, and also connecting an end of another one of the resistors R to the second output pin 4 of the constant current driving chip 30 and an opposite end to the grounding line, connecting the control source 10 to the control pin 5.

Step 4: repeating Step 3 until a predetermined number of the LED light bars 20 are connected.

If replacement is made on a 8-channel highly-integrated constant current driving chip, then four dual-channel constant current driving chips 30 are used and Step 3 are repeated three time to effect connections with eight LED light bars. If replacement is made on a 16-channel highly-integrated constant current driving chip, then eight dual-channel constant current driving chips 30 are used and Step 3 are repeated seven time to effect connections with sixteen LED light bars.

Step 5: activating the control source 10 and the power source 40 so as to apply the control source 10 to control the corresponding LED light bars to conduct on or cut off.

Using the output of high level or low level of the control source 10 to control the field-effect transistors Q1, Q2 to conduct on or cut off and thus controlling the LED light bars 20 to conduct on or cut off is safe and reliable.

Spreading the heat loss of a conventionally used highly-integrated constant current driving chips to a plurality of dual-channel constant current driving chips 30 allows reduction of the operation temperature of each individual constant current driving chip 30 so as to overcome the heat generation issue caused by high integration of the conventional constant current driving chips and improve stability and reliability of products.

The method is applicable to various fields, such as backlight driving of liquid crystal display device and LED lighting.

Referring to FIG. 3, the present invention also provides an LED light bar driving circuit, which comprises a power source 40, two LED light bars 20, a dual-channel constant current driving chip 30, two resistors R, and a control source 10. Each of the LED light bars 20 comprises a positive terminal and a negative terminal. The constant current driving chip 30 comprises a first input pin 1, a second input pin 3, a first output pin 2, a second output pin 4, and a control pin 5. The positive terminal and the negative terminal of one of the LED light bars 20 are respectively connected to the power source 40 and the first input pin 1 of the constant current driving chip 30. The positive terminal and the negative terminal of another one of the LED light bars 20 are respectively connected to the power source 40 and the second input pin 3 of the constant current driving chip 30. One of the resistors R has an end connected to the first output pin 1 of the constant current driving chip 30 and an opposite end connected to a grounding line. Another one of the resistors R has an end connected to the second output pin 4 of the constant current driving chip 30 and an opposite end connected to the grounding line. The control pin 5 is electrically connected to the control source 10.

By using the LED light bar driving circuit according to the present invention, a conventional multi-channel highly-integrated constant current driving chip can be replaced by the dual-channel constant current driving chips 30 so that heat loss of the conventional highly-integrated constant current driving chip can be spread to a plurality of dual-channel constant current driving chips 30 to reduce the operation temperature of each individual constant current driving chip so as to overcome the heat generation issue caused by high integration of the conventional constant current driving chips and improve stability and reliability of products. If replacement is made on a 8-channel highly-integrated constant current driving chip, then four dual-channel constant current driving chips 30 are used and connections with eight LED light bars 20 can be achieved by following the way of connection described above, as shown in FIG. 3. If replacement is made on a 16-channel highly-integrated constant current driving chip, then eight dual-channel constant current driving chips 30 are connections with sixteen LED light bars 20 can be achieved by following the way of connection described above.

Each of the constant current driving chips 30 integrates therein two field-effect transistors (Q1 and Q2) or two triodes to realize dual-channel control. The control source 10 supplies a high level or a low level so as to control the field-effect transistors (Q1, Q2) or the triodes contained in the constant current driving chip 30 to conduct on or cut off. The high level is greater than the voltage of the drain terminal d when the field-effect transistor Q1, Q2 is conducted on.

The constant current driving chips 30 each also comprise two voltage comparators D1, D2. Each of the voltage comparators D1, D2 has an output pin electrically connected to a gate terminal g of the one of the field-effect transistors Q1, Q2 that corresponds to the voltage comparator D1, D2, a negative pin electrically connected to a drain terminal d of the field-effect transistor Q1, Q2, and a positive pin electrically connected to the control source 10. The control source 10 supplies a high level or a low level, of which the high level is greater than the voltage of the drain terminal d when the field-effect transistor Q1, Q2 is conducted on and is also greater than a threshold voltage of the field-effect transistor Q1, Q2 so as to control the conduction or cutoff of the field-effect transistor Q1, Q2 or the triode contained in the constant current driving chip 30, wherein when the control source 10 supplies a high level, the voltage of the positive pin of the voltage comparator D1, D2 is higher than that of the negative pin and thus the output pin supplies a high level to thereby control the corresponding field-effect transistor Q1, Q2 to conduct on and when the control source 10 supplies a low level, the voltage of the positive pin of the voltage comparator D1, D2 is lower than that of the negative pin and thus the output pin supplies a low level to thereby control the corresponding field-effect transistor Q1, Q2 to cut off.

The resistances of the resistors R are determined according to the desired brightness of the LED light bars 20 and the resistances of the resistors R can be identical or different. If the resistances of the resistors R are identical, then the brightness of each of the plurality of LED light bars 20 is identical. If the resistances of the resistors R are different, then the brightness of each of the plurality of LED light bars 20 is different so that applications thereof can be made to various occasions for atmosphere making.

The driving circuit is applicable to various fields, such as backlight driving circuit of liquid crystal display device and LED lighting circuit.

In summary, the present invention provides a method for overcoming excessively high temperature of a constant current driving chip, which comprises a plurality of dual-channel constant current driving chips to replace a conventional 8-channel or 16-channel highly integrated constant current driving chip for driving LED light bars, whereby by reducing the number of channels contained in each individual constant current driving chip, the operation temperature of each individual constant current driving chip can be reduced so as to ensure the performance of products and overcome the heat generation issue caused by high integration of a constant current driving chip and improve stability and reliability of products. The present invention also provides an LED light bar driving circuit, which uses dual-channel constant current driving chips in order to effectively reduce heat emission of each individual constant current driving chip, lower down the operation temperature of the constant current driving chip, and improve stability and reliability of products.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A method for overcoming excessively high temperature of a constant current driving chip, comprising the following steps:
(1) providing a plurality of constant current driving chips, wherein the constant current driving chips are dual-channel constant current driving chips and each of the constant current driving chips comprises a first input pin, a second input pin, a first output pin, a second output pin, and a control pin;
(2) providing a control source, a power source, and a plurality of LED light bars and a plurality of resistors both having a number corresponding to that of the constant current driving chips, each of the LED light bars having a positive terminal and a negative terminal;
(3) respectively connecting the positive terminal and the negative terminal of one of the LED light bars to the power source and the first input pin of one of the constant current driving chips and respectively connecting the positive terminal and the negative terminal of another one of the LED light bars to the power source and the second input pin of the constant current driving chip, also connecting an end of one of the resistors to the first output pin of the constant current driving chip and an opposite end to a grounding line, and also connecting an end of another one of the resistors to the second output pin of the constant current driving chip and an opposite end to the grounding line, connecting the control source to the control pin;
(4) repeating Step 3, until a predetermined number of the LED light bars are connected; and
(5) activating the control source and the power source so as to apply the control source to control the corresponding LED light bars to conduct on or cut off.

2. The method for overcoming excessively high temperature of a constant current driving chip as claimed in claim 1, wherein each of the constant current driving chips integrates therein two field-effect transistors or two triodes.

3. The method for overcoming excessively high temperature of a constant current driving chip as claimed in claim 2, wherein the control source supplies a high level or a low level to control the field-effect transistors or the triodes contained in the constant current driving chips to conduct on or cut off, the high level being greater than voltage of the drain terminal when the field-effect transistor is conducted on and being also greater than a threshold voltage of the field-effect transistor.

4. The method for overcoming excessively high temperature of a constant current driving chip as claimed in claim 1, wherein the resistances of the resistors are determined according to predetermined brightness of the LED light bars.

5. An LED (light emitting diode) light bar driving circuit, comprising a power source, two LED light bars, a dual-channel constant current driving chip, two resistors, and a control source, each of the LED light bars comprising a positive terminal and a negative terminal, the constant current driving chip comprising a first input pin, a second input pin, a first output pin, a second output pin, and a control pin, the positive terminal and the negative terminal of one of the LED light bars being respectively connected to the power source and the first input pin of the constant current driving chip, the positive terminal and the negative terminal of another one of the LED light bars being respectively connected to the power source and the second input pin of the constant current driving chip, one of the resistors having an end connected to the first output pin of the constant current driving chip and an opposite end connected to a grounding line, another one of the resistors having an end connected to the second output pin of the constant current driving chip and an opposite end connected to the grounding line, the control pin being electrically connected to the control source.

6. The LED light bar driving circuit as claimed in claim 5, wherein each of the constant current driving chips integrates therein two field-effect transistors or two triodes.

7. The LED light bar driving circuit as claimed in claim 6, wherein the control source supplies a high level or a low level to control the field-effect transistors or the triodes contained in the constant current driving chips to conduct on or cut off, the high level being greater than voltage of the drain terminal when the field-effect transistor is conducted on and being also greater than a threshold voltage of the field-effect transistor.

8. The LED light bar driving circuit as claimed in claim 5, wherein the resistances of the resistors are determined according to predetermined brightness of the LED light bars.

9. A method for overcoming excessively high temperature of a constant current driving chip, comprising the following steps:
(1) providing a plurality of constant current driving chips, wherein the constant current driving chips are dual-channel constant current driving chips and each of the constant current driving chips comprises a first input pin, a second input pin, a first output pin, a second output pin, and a control pin;
(2) providing a control source, a power source, and a plurality of LED light bars and a plurality of resistors both having a number corresponding to that of the constant current driving chips, each of the LED light bars having a positive terminal and a negative terminal;
(3) respectively connecting the positive terminal and the negative terminal of one of the LED light bars to the power source and the first input pin of one of the constant current driving chips and respectively connecting the positive terminal and the negative terminal of another one of the LED light bars to the power source and the second input pin of the constant current driving chip, also connecting an end of one of the resistors to the first output pin of the constant current driving chip and an opposite end to a grounding line, and also connecting an end of another one of the resistors to the second output pin of the constant current driving chip and an opposite end to the grounding line, connecting the control source to the control pin;
(4) repeating Step 3, until a predetermined number of the LED light bars are connected; and
(5) activating the control source and the power source so as to apply the control source to control the corresponding LED light bars to conduct on or cut off;
wherein each of the constant current driving chips integrates therein two field-effect transistors or two triodes;
wherein the control source supplies a high level or a low level to control the field-effect transistors or the triodes contained in the constant current driving chips to conduct on or cut off, the high level being greater than voltage of the drain terminal when the field-effect transistor is conducted on and being also greater than a threshold voltage of the field-effect transistor; and
wherein the resistances of the resistors are determined according to predetermined brightness of the LED light bars.
